(19) United States
(12) Patent Application Publication
(10) Pub. No.: US 2018/0363359 A1
(43) Pub. Date: Dec. 20, 2018

(54) VEHICLE DOOR NON-CONTACT OPEN APPARATUS

(71) Applicant: HONDA MOTOR CO., LTD., Tokyo (JP)

(72) Inventors: Tomonori Watanabe, Wako-shi (JP); Nobuyuki Kishikawa, Wako-shi (JP); Kenji Shioiri, Wako-shi (JP); Mitsunori Nishino, Wako-shi (JP); Yoichi Katayama, Wako-shi (JP)

(21) Appl. No.: 15/979,580

(22) Filed: May 15, 2018

(30) Foreign Application Priority Data
Jun. 19, 2017 (JP) 2017-119406

(51) Int. Cl. E05F 15/73

(52) U.S. Cl. CPC E05F 15/73; E05B 81/78; E05Y 2900/531

(57) ABSTRACT

A vehicle door non-contact open apparatus includes: a detection part, a control part, and an actuator. The detection part detects an object and measures a distance to the object. The control part stores the distance which is measured by the detection part as an initial value and outputs a door open signal according to the stored initial value. The actuator opens a door to the object according to the door open signal from the control part.

### CROSS-REFERENCE TO RELATED APPLICATION

Priority is claimed on Japanese Patent Application No. 2017-119406, filed on Jun. 19, 2017, the contents of which are incorporated herein by reference.

### BACKGROUND

### Field of the Invention

The present invention relates to a vehicle door non-contact open apparatus.

### Background

As a vehicle door non-contact open apparatus, an apparatus is known which unlocks and opens a vehicle door without the hand of a user coming into contact with the vehicle door. According to the vehicle door non-contact open apparatus, for example, when the hand of the user is occupied, it is possible to open the door in a non-contact state without touching the door. Specifically, for example, a laser beam that is emitted from a vehicle is blocked by the foot of the user, and the distance of the laser beam is changed. By detecting the distance of the laser beam, it is determined that a command to open the door is made. Thereby, a door lock is unlocked, a door latch is released, and the door is opened by a biasing force of a spring (for example, refer to Japanese Patent Application, Publication No. 2007-162459A).

### SUMMARY

In the vehicle door non-contact open apparatus of Japanese Patent Application, Publication No. 2007-162459A, when it is determined that a command to open the door is made, the door is opened by the biasing force of the spring in response to the command to open the door. Therefore, there may be a case in which it is impossible to open the door to an open position required by the user. Alternatively, there may be a case in which the door is opened beyond an open position required by the user. In this case, it is necessary to place the door manually back to the required open position from the position of the door that is opened by the biasing force of the spring.

From this viewpoint, practical realization of a technique has been desired which is capable of opening a door in a non-contact state without touching the door to an open position that is required by a user.

An aspect of the present invention is to provide a vehicle door non-contact open apparatus that is capable of easily opening a door to an open position that is required by a user.

(1) A vehicle door non-contact open apparatus according to an aspect of the present invention includes: a detection part that is configured to detect an object and that is configured to measure a distance to the object; a control part that is configured to store the distance which is measured by the detection part as an initial value and that is configured to output a door open signal according to the stored initial value; and an actuator that is configured to open a door to the object according to the door open signal from the control part.

In this way, the door is opened to the object by the actuator according to the door open signal from the control part. Thereby, by placing an object at an open position that is required by a user, it is possible to easily open the door to the open position that is required by the user in a non-contact state without touching the door.

(2) In the vehicle door non-contact open apparatus described above, the control part may transmit the door open signal to the actuator from the control part even when the object is separated from a detection range of the detection part after the initial value is stored.

In this way, the door open signal is transmitted to the actuator from the control part even when separating the object from the detection range after the control part stores the initial value. Thereby, for example, when the hand of the user is occupied, it is enough for the user to place the object only for a short period of time until the control part stores the initial value. Thereby, it is possible to further easily open the door to the open position that is required by the user.

(3) In the vehicle door non-contact open apparatus described above, when the object is placed again in the detection range, an emergency stop signal may be output to the actuator from the control part.

In this way, when the object is placed again in the detection range, the emergency stop signal is output to the actuator from the control part. Thereby, by a simple operation that only places the object again in the detection range, it is possible to adjust the open state of the door, and it is possible to further improve the usability of the vehicle.

(4) In the vehicle door non-contact open apparatus described above, the control part may intermittently measure and acquire a distance between the object and the door as an intermittent distance after storing the initial value, may acquire a distance by which the door is opened as an open distance in accordance with the intermittent measurement, and may output an emergency stop signal to the actuator from the control part when a value obtained by adding the open distance to the intermittent distance is different from the initial value.

In this way, the emergency stop signal is output to the actuator from the control part when the value obtained by adding the open distance to the intermittent distance is different from the initial value. For example, when the user separates the object from the detection range, the value obtained by adding the open distance to the intermittent distance is different from the initial value. Therefore, by the user separating the object from the detection range, it is possible to stop opening of the door, and it is possible to further improve the usability of the vehicle.

(5) In the vehicle door non-contact open apparatus described above, the control part may transmit the door open signal to the actuator according to the initial value when it is detected that the object is a palm and may output an emergency stop signal to the actuator from the control part when an obstacle is arranged between the door and the palm.

In this way, when the object is a palm, the door open signal is transmitted to the actuator according to the distance to the palm. Further, when an obstacle is arranged between the door and the palm, an emergency stop signal is output to the actuator from the control part. Thereby, it is possible to prevent the door from interfering with the obstacle, and it is possible to further improve the usability of the vehicle.

According to an aspect of the present invention, the door is opened to the object by the actuator according to the door open signal from the control part. Thereby, it is possible to easily open the door to the open position that is required by the user in a non-contact state without touching the door.

### BRIEF DESCRIPTION OF THE DRAWINGS

FIG. 1 is a plan view showing a state in which a vehicle door of a vehicle that includes a vehicle door non-contact open apparatus is closed in a first embodiment of the present invention.

FIG. 2 is a block diagram showing the vehicle door non-contact open apparatus in the first embodiment of the present invention.

FIG. 3 is a plan view showing a state in which the vehicle door of the vehicle that includes the vehicle door non-contact open apparatus is opened in the first embodiment of the present invention.

FIG. 4 is a flowchart showing a method of detecting the hand of a user by the vehicle door non-contact open apparatus in the first embodiment of the present invention.

Part (A) of FIG. 5 is a plan view showing an object (that is, the hand of the user) to be detected by the vehicle door non-contact open apparatus in the first embodiment of the present invention, part (B) of FIG. 5 is a plan view showing a first pattern for recognizing the object that is detected by the vehicle door non-contact open apparatus as the hand, and part (C) of FIG. 5 is a plan view showing a second pattern for recognizing the object that is detected by the vehicle door non-contact open apparatus as the hand.

FIG. 6 is a flowchart showing a method of opening a vehicle front side door by the vehicle door non-contact open apparatus in the first embodiment of the present invention.

FIG. 7 is a plan view showing the method of opening the vehicle front side door by the vehicle door non-contact open apparatus in the first embodiment of the present invention.

FIG. 8 is a graph showing an example in which the vehicle front side door is opened by the vehicle door non-contact open apparatus in the first embodiment of the present invention.

FIG. 9 is a plan view showing a method of opening the vehicle front side door to a midway by the vehicle door non-contact open apparatus in a second embodiment of the present invention.

FIG. 10 is a plan view showing a method of opening the vehicle front side door from the open midway to a predetermined open position by the vehicle door non-contact open apparatus in the second embodiment of the present invention.

FIG. 11 is a graph showing an example in which the vehicle front side door is opened by the vehicle door non-contact open apparatus in the second embodiment of the present invention.

### DESCRIPTION OF THE EMBODIMENTS

An embodiment of the present invention will be described with reference to the drawings. In the drawings, an arrow FR indicates a frontward direction of a vehicle, an arrow UP indicates an upward direction of the vehicle, and an arrow LH indicates a leftward direction of the vehicle.

### First Embodiment

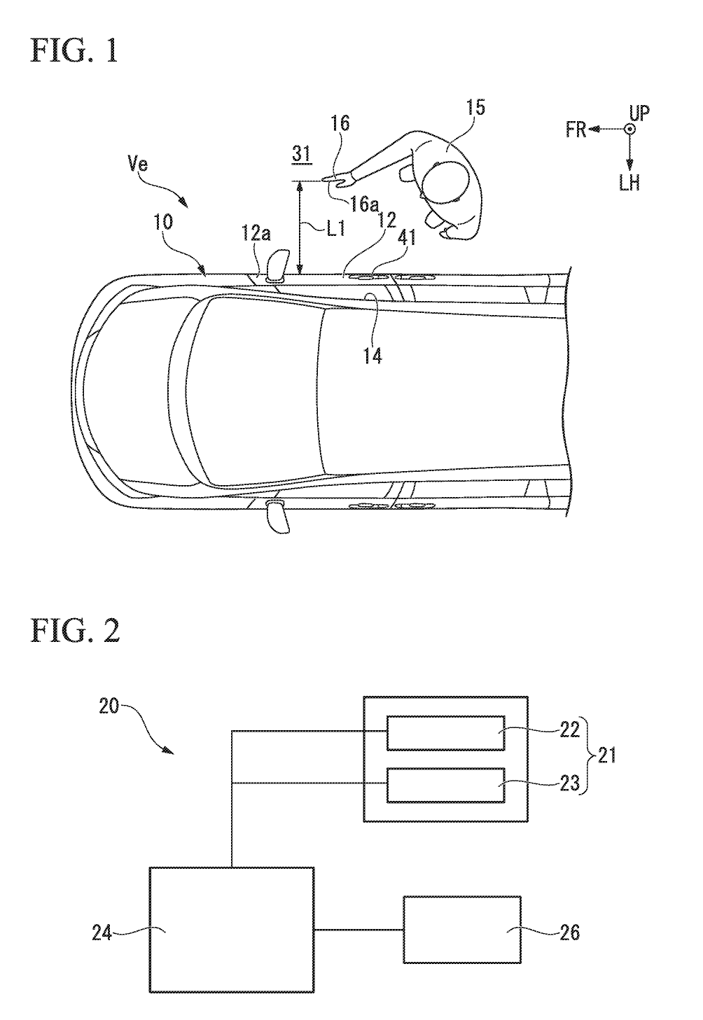

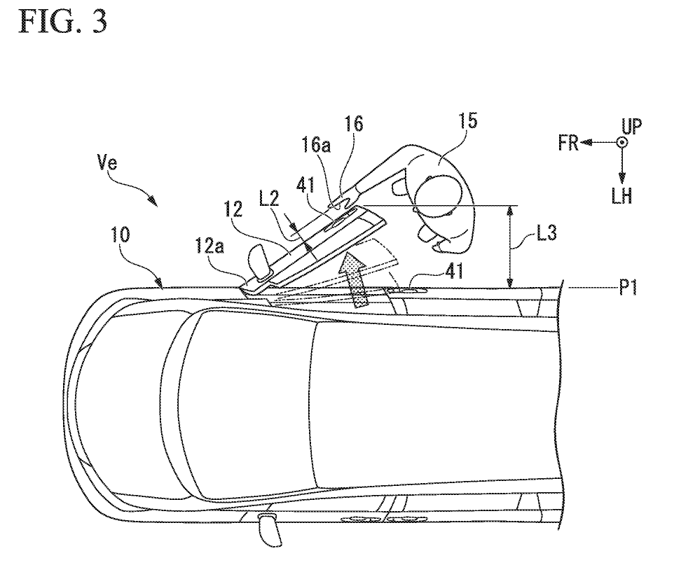

As shown in FIG. 1 and FIG. 2, a vehicle Ve includes a vehicle body 10, a front side door 12 (door), and a vehicle door non-contact open apparatus 20. The vehicle door non-contact open apparatus 20 includes a detection part 21, a control part 24, and an actuator 26.

The front side door 12 is supported to be openable and closeable in a vehicle width direction. A front end part 12a of the front side door 12 is supported, for example, by a front opening part 14 of the vehicle body 10 via a hinge.

The detection part 21 includes a first detection unit 22 and a second detection unit 23.

The first detection unit 22 is provided on the front side door 12. Examples of the first detection unit 22 include an IR sensor (infrared sensor), a distance image sensor (TOF (Time of Flight) method), a camera for automated driving or surround viewing, and an ultrasonic sensor. The embodiment is described using an ultrasonic sensor as an example. The first detection unit 22 transmits ultrasonic waves to an object 16 that is arranged in a detection range of the first detection unit 22 and receives the ultrasonic waves reflected from the object 16.

The first detection unit 22 separates the element of the shape of the object 16 into two patterns on the basis of received data.

The second detection unit 23 is provided on the front side door 12. Examples of the second detection unit 23 include an IR sensor (infrared sensor), a distance image sensor (TOF (Time of Flight) method), a stereo camera, and an ultrasonic sensor. The embodiment is described using an ultrasonic sensor as an example. The second detection unit 23 transmits ultrasonic waves to an object 16 that is placed in a detection range of the second detection unit 23 and receives the ultrasonic waves reflected from the object 16. The second detection unit 23 measures a “time” from the transmission to the reception and thereby measures the distance to the object 16.

That is, the second detection unit 23 detects the object 16 in the detection range and measures the distance to the object 16.

The control part 24 determines whether or not the object 16 falls into a predetermined pattern (that is, a first pattern (refer to part (B) of FIG. 5) or a second pattern (refer to part (C) of FIG. 5) on the basis of data of the object 16 that is detected by the first detection unit 22. When the object 16 falls into the first pattern or the second pattern, the control part 24 determines that the object 16 is a hand.

Further, when it is determined that the object 16 in the detection range 31 is a hand, the control part 24 transmits a door open signal to the actuator 26 on the basis of the distance to a palm 16a of the hand 16. When an obstacle is arranged between the front side door 12 and the palm 16a in the detection range 31, the control part 24 outputs an emergency stop signal from the control part 24 to the actuator 26.

The control part 24 stores the distance that is measured by the second detection unit 23 as an initial value L1 and outputs the door open signal to the actuator 26 on the basis of the stored initial value L1.

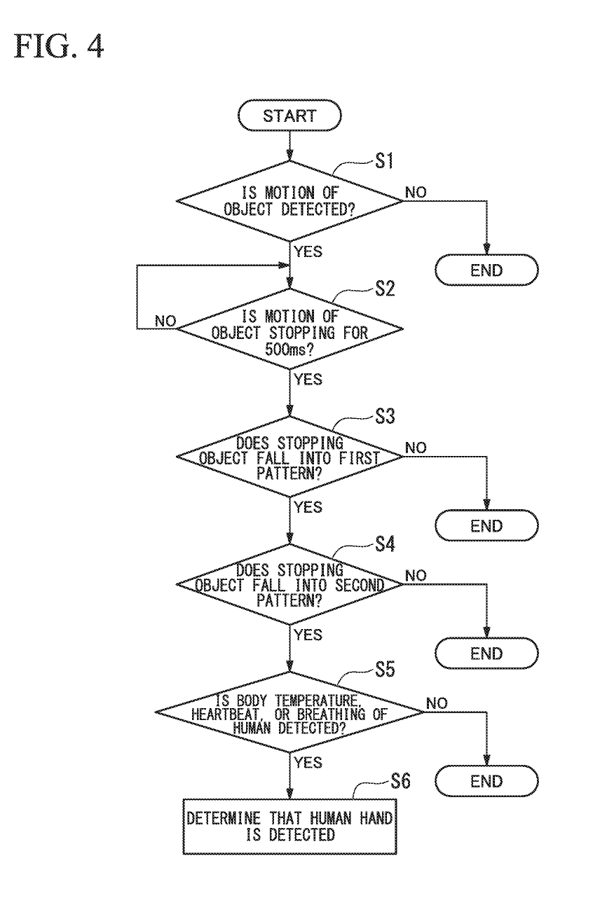

As shown in FIG. 3, the control part 24 intermittently measures and acquires the distance between the object 16 and the front side door 12 as an intermittent distance L2 after storing the initial value L1 (refer to FIG. 1). Further, the control part 24 acquires a distance by which the front side door 12 is opened from a closed position P1 as an open distance L3 in accordance with the intermittent measurement.

Further, the control part 24 outputs the emergency stop signal to the actuator 26 from the control part 24 when a value obtained by adding the open distance L3 to the intermittent distance L2 is different from the initial value L1.

With reference to FIG. 1 and FIG. 2 again, the actuator 26 opens the front side door 12 to the object 16 on the basis of the door open signal from the control part 24. Examples of the actuator 26 include a drive motor and a gear unit. According to the actuator 26, the drive motor is rotated on the basis of the door open signal from the control part 24. The speed of rotation of the drive motor is reduced to an appropriate rotation speed by the gear unit, and the front side door 12 is opened by using the rotation at the reduced speed.

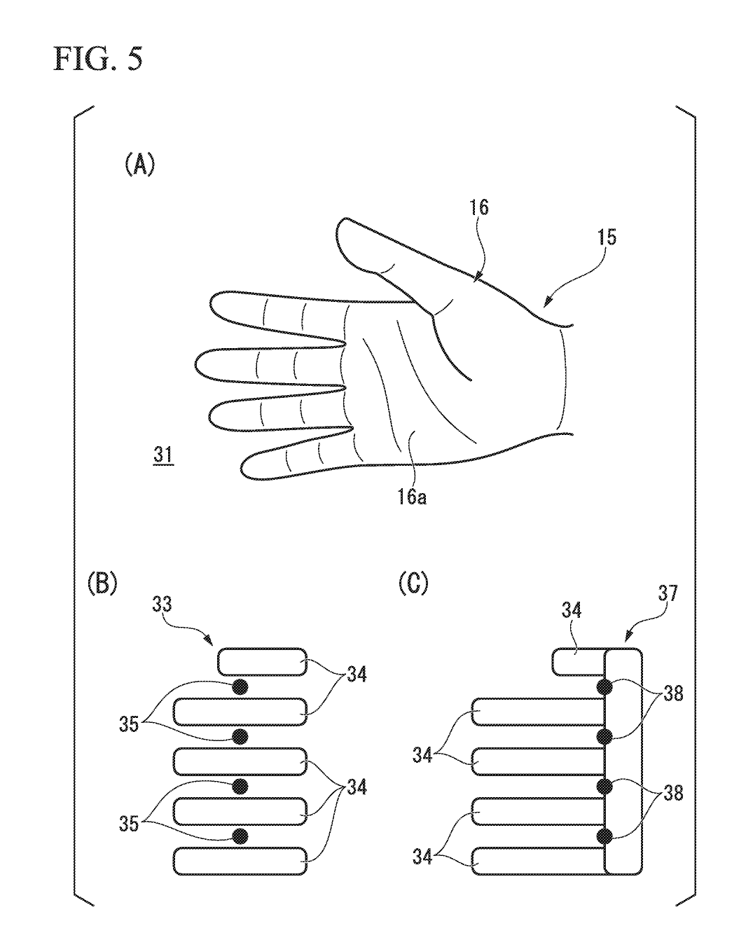

Next, a method of detecting the hand 16 of a user 15 by the vehicle door non-contact open apparatus 20 is described with reference to the flowchart of FIG. 4 and part (A) to part (C) of FIG. 5.

As shown in FIG. 4 and part (A) of FIG. 5, the hand 16 (hereinafter, referred to as the object) of a user 15 is placed in the detection range 31 of the detection part 21 (refer to FIG. 2). In Step S1, it is determined whether or not the detected object 16 is moving. For example, when the object 16 enters the detection range 31, or when the object 16 is swung in the detection range 31 in the vertical direction or in the vehicle width direction, it is determined that the object 16 is moving.

On the other hand, when the object 16 is stopping, it is determined that the object 16 is not moving. When it is determined that the object 16 is moving, the routine proceeds to Step S2.

In Step S2, it is determined whether or not the motion of the object 16 is stopping for 500 ms.

When it is determined that the motion of the object 16 is not stopping for 500 ms, the operation of Step S2 is repeated. When it is determined that the motion of the object 16 is stopping for 500 ms, the routine proceeds to Step 3.

In Step S3, it is determined whether or not the stopping object 16 falls into a first pattern 33 shown in part (B) of FIG. 5.

The first pattern 33 is a pattern in which two to four gaps 35 are formed between three to five linear objects 34.

When it is determined that the object 16 falls into the first pattern 33, the routine proceeds to Step S4.

In Step S4, it is determined whether or not the stopping object 16 falls into a second pattern 37 shown in part (C) of FIG. 5.

The second pattern 37 is a pattern in which three to five linear objects 34 are connected by a connection part 38 at any one of right and left end parts of the linear objects 34.

When it is determined that the object 16 falls into the second pattern, the routine proceeds to Step S5.

In Step S5, it is determined whether or not at least one of the body temperature of the user 15, the heartbeat of the user 15, and the breathing of the user 15 is detected. When at least one of the body temperature of the user 15, the heartbeat of the user 15, and the breathing of the user 15 is detected, it is determined in Step S6 that the object 16 is the hand 16 of the user.

In order to detect the body temperature of the user 15, the heartbeat of the user 15, and the breathing of the user 15, a body temperature detection part that detects the body temperature of the user 15 is provided on the vehicle body 10. In order to detect the heartbeat of the user 15, a heartbeat detection part that detects the heartbeat of the user 15 is provided on the vehicle body 10. In order to detect the breathing of the user 15, a breathing detection part that detects the breathing of the user 15 is provided on the vehicle body 10.

In the flowchart of FIG. 4, an example is described in which it is determined whether or not at least one of the body temperature of the user 15, the heartbeat of the user 15, and the breathing of the user 15 is detected in Step S5; however, the embodiment is not limited thereto. As another example, it is possible to omit Step S5.

Even when Step S5 is omitted, it is possible to determine in Step S6 that the object 16 is the hand of the user.

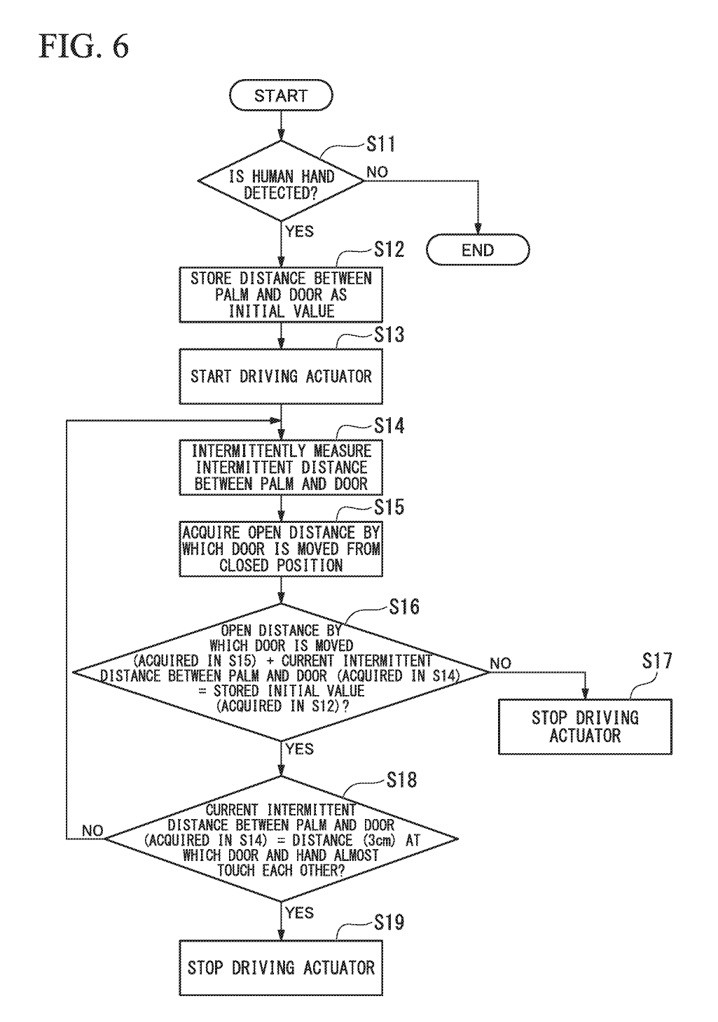

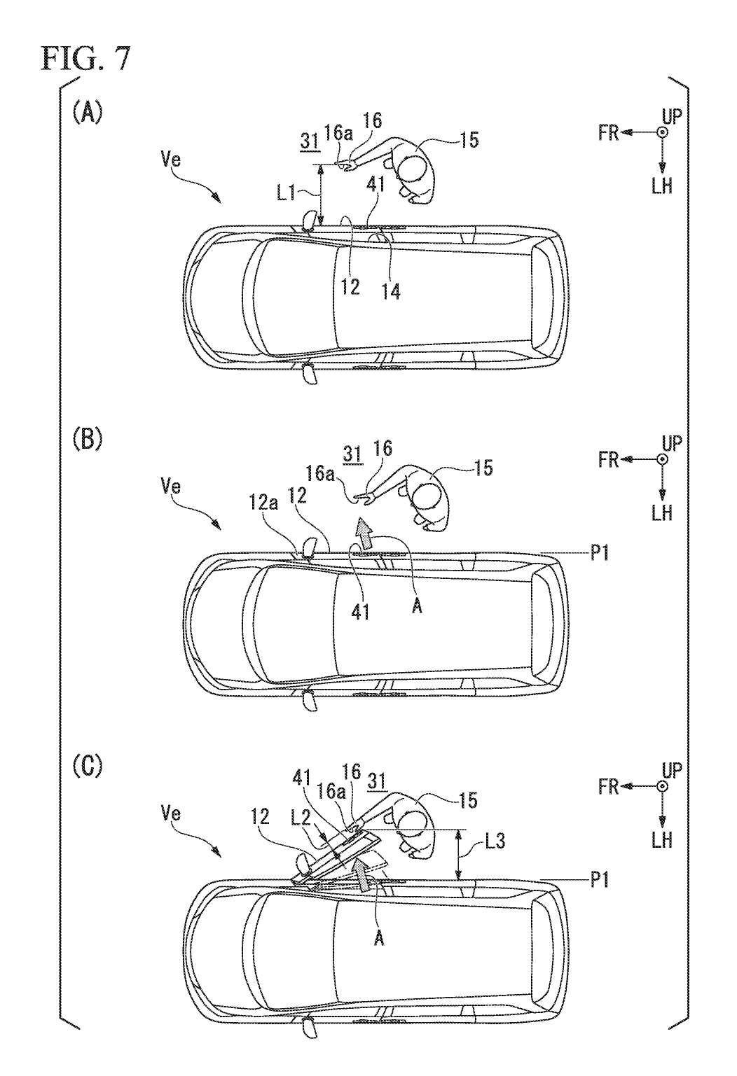

Next, a method of opening the front side door 12 of the vehicle Ve by the vehicle door non-contact open apparatus 20 is described with reference to the flowchart of FIG. 6 and FIG. 7. For ease of understanding the vehicle door non-contact open apparatus 20, it is assumed that the front side door 12 is maintained in an unlocked state before the front side door 12 is opened by the vehicle door non-contact open apparatus 20.

As shown in FIG. 6 and part (A) of FIG. 7, in Step S11, when it is not determined that the object 16 is the hand 16 of the user 15, a non-contact open operation of the front side door 12 is finished.

Specifically, for example, when an obstacle is arranged between the front side door 12 and the palm 16a, an emergency stop signal is output to the actuator 26 from the control part 24. Thereby, it is possible to prevent the front side door 12 from being opened and interfering with the obstacle, and it is possible to improve the usability of the vehicle Ve.

The procedure of determining that the object 16 is the hand 16 of the user 15 is described using the flowchart of FIG. 4.

In Step S11, when it is determined that the object 16 is the hand 16 of the user 15, the routine proceeds to Step S12. In Step S12, the distance between the hand 16 (specifically, the palm 16a) and the front side door 12 is stored as the initial value L1. The palm 16a is placed in the detection range 31. The front side door 12 is arranged in a state where the front opening part 14 of the vehicle Ve is closed.

As shown in FIG. 6 and part (B) of FIG. 7, in Step S13, the drive motor of the actuator 26 (refer to FIG. 2) is started. The drive motor of the actuator 26 is rotated, and thereby, the front side door 12 is opened from the closed position P1 in an arrow A direction using the hinge of the front end part 12a as a fulcrum point.

As shown in FIG. 6 and part (C) of FIG. 7, in Step S14, the distance between the palm 16a and the front side door 12 is intermittently measured and acquired as an intermittent distance L2. In Step S15, the distance between the palm 16a and the front side door 12 is acquired as an open distance L3 in accordance with the intermittent measurement. The open distance L3 is a distance by which the front side door 12 is opened from the closed position P1.

In Step S16, when a value obtained by adding the open distance L3 to the intermittent distance L2 is different from the initial value L1, the routine proceeds to Step S17.

In Step S17, the actuator 26 (refer to FIG. 2) is stopped. Thereby, it is possible to stop the front side door 12 being opened.

A specific example in which the value obtained by adding the open distance L3 to the intermittent distance L2 is different from the initial value L1 is described. For example, when the user 15 separates the palm 16a (that is, the hand 16) from the detection range 31, the value obtained by adding the open distance L3 to the intermittent distance L2 is different from the initial value L1. Accordingly, for example, the user 15 separates the hand 16 from the detection range 31, and thereby, it is possible to stop the front side door 12 being opened. Thereby, it is possible to enhance the usability of the vehicle Ve.

On the other hand, in Step S16, when the value obtained by adding the open distance L3 to the intermittent distance L2 is matched to the initial value L1, the routine proceeds to Step S18. In Step S18, it is determined whether or not the intermittent distance L2 is matched to a close distance at which the front side door 12 and the hand (that is, the palm 16a) almost touch each other. The close distance refers to, for example, a case in which the distance between the front side door 12 and the palm 16a is 3 cm. A distance that is smaller than 3 cm or a distance that is larger than 3 cm can be the close distance.

When the intermittent distance L2 is different from the close distance (specifically, the intermittent distance L2 is larger than the close distance), the routine returns to Step S14. On the other hand, when the intermittent distance L2 is matched to the close distance, the routine proceeds to Step S19. In Step S19, the actuator 26 (refer to FIG. 2) is stopped. Thereby, it is possible to stop the front side door 12 being opened.

In this way, the front side door 12 is opened to the hand 16 (that is, the palm 16a) of the user 15 by the actuator 26 on the basis of the door open signal from the control part 24 (refer to FIG. 2). Thereby, by placing the hand 16 at an open position that is required by the user 15, it is possible to easily open the front side door 12 to the open position that is required by the user 15 in a non-contact state without the hand 16 touching a door handle 41 of the front side door 12.

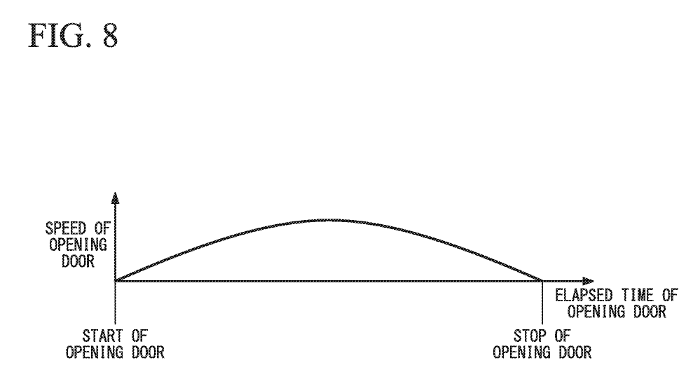

Further, by determining the initial value L1 by the palm 16a of the user 15, it is possible to clarify the open start (that is, an open start position) and the open stop (that is, an open stop position) of the front side door 12. Thereby, it is possible to realize a linear open operation of the front side door 12. The linear open operation of the front side door 12 is described with reference to FIG. 7 and the graph of FIG. 8.

In the graph of FIG. 8, the vertical axis represents an open speed when the front side door 12 is opened, and the horizontal axis represents an open elapsed time when the front side door 12 is opened.

As shown in the graph of FIG. 8, the front side door 12 can moderately increase the open speed from the open start to a midway of the open stop. The midway of the open stop refers to the substantially middle of the open start and the open stop.

After the open speed is moderately increased to the midway of the open stop, the front side door 12 can moderately decrease the open speed toward the open stop. Thereby, it is possible to open the front side door 12 by a smooth continuous operation from the open start to the open stop. In other words, it is possible to open the front side door 12 by a linear operation similar to a case in which the user 15 grips the door handle 41 by the hand 16 and opens the front side door 12.

The first embodiment is described using an example in which the front side door 12 is opened in a state where the hand 16 of the user 15 is placed in the detection range 31; however, the embodiment is not limited thereto. Other examples are described using a first modified example and a second modified example.

### FIRST MODIFIED EXAMPLE

The first modified example is configured such that, even when the hand 16 of the user 15 is separated from the detection range 31 after the initial value L1 is stored in the control part 24 (refer to FIG. 2), the door open signal is transmitted to the actuator 26 from the control part 24 on the basis of the stored initial value L1.

Accordingly, for example, when the hand 16 of the user 15 is occupied, it is enough for the user 15 to keep the hand 16 in the detection range 31 only for a short period of time until the control part 24 stores the initial value L1. Thereby, it is possible to easily open the front side door 12 to the open position that is required by the user 15.

### SECOND MODIFIED EXAMPLE

The second modified example is configured such that, when the hand 16 of the user 15 is placed again in the detection range 31, an emergency stop signal is output to the actuator 26 from the control part 24.

For example, when the front side door 12 continues to be opening in a state where the hand 16 of the user 15 is separated from the detection range 31, there is a case in which the user 15 wants to stop the front side door 12. In this case, the hand 16 of the user 15 is placed again in the detection range 31, and thereby, it is possible to output the emergency stop signal to the actuator 26 from the control part 24.

Thereby, by a simple operation that only places the hand 16 again in the detection range, it is possible to adjust the open position of the front side door 12, and it is possible to enhance the usability of the vehicle Ve.

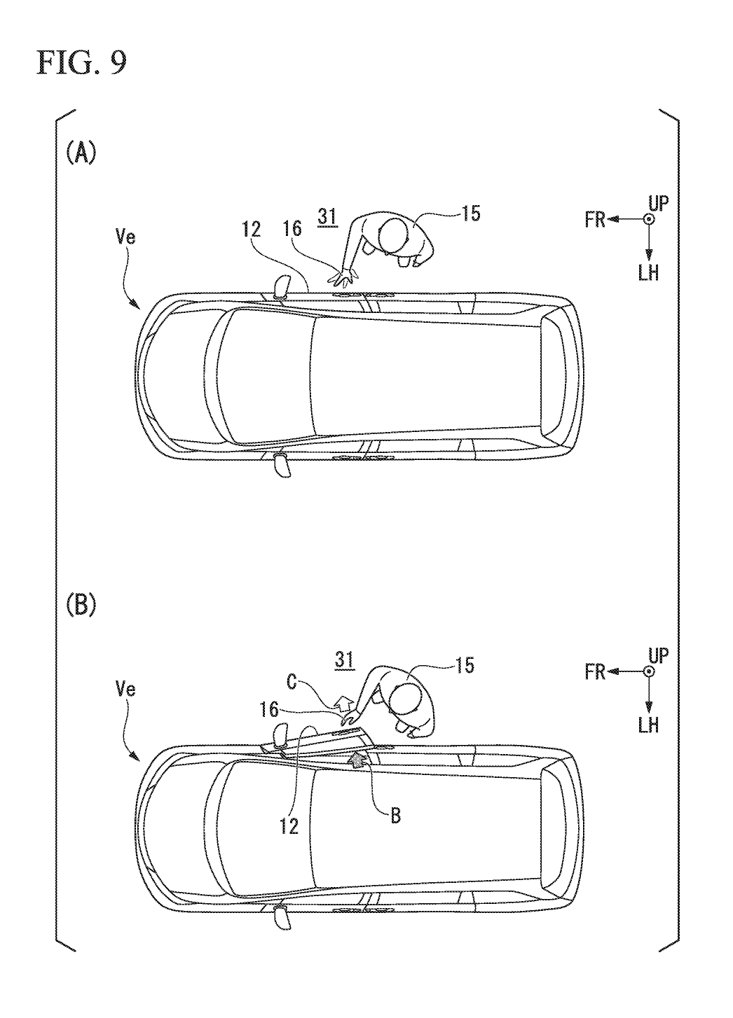

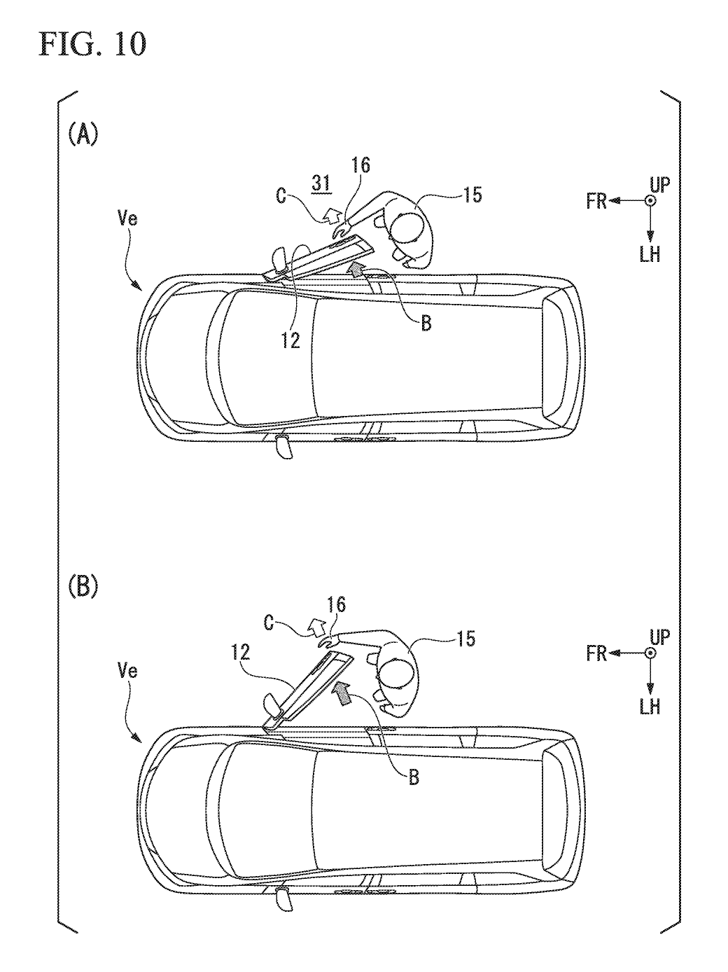

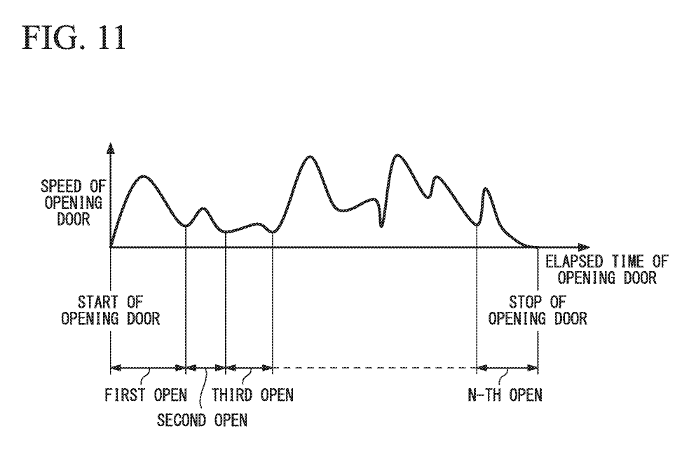

Next, a method of opening the front side door 12 by the vehicle door non-contact open apparatus of a second embodiment is described with reference to FIG. 9, FIG. 10, and the graph of FIG. 11. In the graph of FIG. 11, the vertical axis represents an open speed when the front side door 12 is opened, and the horizontal axis represents an open elapsed time when the front side door 12 is opened.

### Second Embodiment

As shown in part (A) of FIG. 9, the hand 16 of the user 15 is placed in the detection range 31. In this state, the hand 16 of the user 15 is shaken. Thereby, the user 15 commands to open the front side door 12.

As shown in part (B) of FIG. 9, the hand 16 of the user 15 is separated outward in the vehicle width direction from the front side door 12 in the detection range 31 and is placed at a position relatively close to the front side door 12.

The front side door 12 starts to be opened, follows up the hand 16 of the user 15, and is opened as represented by an arrow B. This open is referred to as a first open.

As shown in the graph of FIG. 11, in the first open, the front side door 12 increases the open speed to a midway of the first open and decreases the open speed from the midway of the first open to the end of the first open.

As shown in part (B) of FIG. 9, the front side door 12 moves to the vicinity of the hand 16 of the user 15 by the first open. In this state, the hand 16 of the user 15 is separated outward in the vehicle width direction from the front side door 12 in the detection range 31 as represented by an arrow C and is placed at a position relatively close to the front side door 12.

As shown in part (A) of FIG. 10, the front side door 12 starts a second open, follows up the hand 16 of the user 15, and is opened as represented by an arrow B.

As shown in the graph of FIG. 11, in the second open, the front side door 12 increases the open speed to a midway of the second open and decreases the open speed from the midway of the second open to the end of the second open.

As shown in part (A) of FIG. 10, the front side door 12 moves to the vicinity of the hand 16 of the user 15 by the second open. In this state, the hand 16 of the user 15 is separated outward in the vehicle width direction from the front side door 12 in the detection range 31 as represented by an arrow C and is placed at a position relatively close to the front side door 12.

As shown in part (B) of FIG. 10, the front side door 12 starts a third open, follows up the hand 16 of the user 15, and is opened as represented by an arrow B.

As shown in the graph of FIG. 11, in the third open, the front side door 12 increases the open speed to a midway of the third open and decreases the open speed from the midway of the third open to the end of the third open.

As shown in part (B) of FIG. 10, the front side door 12 moves to the vicinity of the hand 16 of the user 15 by the third open. In this state, the hand 16 of the user 15 is separated outward in the vehicle width direction from the front side door 12 in the detection range 31 as represented by an arrow C and is placed at a position relatively close to the front side door 12.

Hereinafter, a fourth open to an N-th open are repeated similarly to the first open to the third open. Thereby, the front side door 12 is opened to a predetermined open position that is required by the user 15 in a non-contact state without the hand 16 touching the door handle 41 of the front side door 12.

In this way, by placing the hand 16 of the user 15 at an open position that is required by the user 15, it is possible to easily open the front side door 12 to the open position that is required by the user 15 in a non-contact state without the hand 16 touching the door handle 41 of the front side door 12.

According to the second embodiment, it is possible to determine the open position of the front side door 12 while looking at the open state of the front side door 12. Thereby, it is possible to easily open the front side door 12 to the open position that is required by the user 15.

Further, according to the second embodiment, it is not necessary to greatly separate the hand 16 of the user 15 from the front side door 12. Thereby, for example, it is possible to moderate the accuracy of the detection part 21 (specifically, the second detection unit 23), and it is possible to reduce the cost of the detection part 21.

The technical scope of the present invention is not limited to the embodiments described above, and a variety of changes can be added without departing from the scope of the invention.

For example, the first embodiment is described using an example in which the detection part 21 includes the first detection unit 22 and the second detection unit 23, the element of the shape of the object 16 is separated into two patterns by the first detection unit 22, and the distance to the object 16 is measured by the second detection unit 23; however, the embodiment is not limited thereto.

As another example, it is also possible to integrate the first detection unit 22 and the second detection unit 23 into one detection unit and to separate the element of the shape of the object 16 into two patterns by the one detection unit and further measure the distance to the object 16.

The first embodiment and the second embodiment are described using an example in which the vehicle door non-contact open apparatus is applied to the front side door 12; however, the embodiment is not limited thereto. As other examples, it is also possible to apply the vehicle door non-contact open apparatus to a rear side door, a flip-up back door, and the like.

What is claimed is:

1. A vehicle door non-contact open apparatus comprising:
a detection part that is configured to detect an object and that is configured to measure a distance to the object;
a control part that is configured to store the distance which is measured by the detection part as an initial value and that is configured to output a door open signal according to the stored initial value; and
an actuator that is configured to open a door to the object according to the door open signal from the control part.

2. The vehicle door non-contact open apparatus according to claim 1,
wherein the control part is configured to transmit the door open signal to the actuator from the control part even when the object is separated from a detection range of the detection part after the initial value is stored.

3. The vehicle door non-contact open apparatus according to claim 2,
wherein, when the object is placed again in the detection range, an emergency stop signal is output to the actuator from the control part.

4. The vehicle door non-contact open apparatus according to claim 1,
wherein the control part is configured to
intermittently measure and acquire a distance between the object and the door as an intermittent distance after storing the initial value,
acquire a distance by which the door is opened as an open distance in accordance with the intermittent measurement, and
output an emergency stop signal to the actuator from the control part when a value obtained by adding the open distance to the intermittent distance is different from the initial value.

5. The vehicle door non-contact open apparatus according to claim 1,
wherein the control part is configured to
transmit the door open signal to the actuator according to the initial value when it is detected that the object is a palm, and
output an emergency stop signal to the actuator from the control part when an obstacle is arranged between the door and the palm.

6. The vehicle door non-contact open apparatus according to claim 2,
wherein the control part is configured to
transmit the door open signal to the actuator according to the initial value when it is detected that the object is a palm, and
output an emergency stop signal to the actuator from the control part when an obstacle is arranged between the door and the palm.

7. The vehicle door non-contact open apparatus according to claim 3,
wherein the control part is configured to
transmit the door open signal to the actuator according to the initial value when it is detected that the object is a palm, and
output an emergency stop signal to the actuator from the control part when an obstacle is arranged between the door and the palm.

8. The vehicle door non-contact open apparatus according to claim 4,
wherein the control part is configured to
transmit the door open signal to the actuator according to the initial value when it is detected that the object is a palm, and
output an emergency stop signal to the actuator from the control part when an obstacle is arranged between the door and the palm.
